(19) United States
(12) Patent Application Publication
(10) Pub. No.: US 2026/0065666 A1
(43) Pub. Date: Mar. 5, 2026

(54) SIGNAL-TO-NOISE METRIC FOR ANNOTATION GUIDANCE, DL MODEL TUNABILITY, AND ROBUSTNESS

(71) Applicant: KLA Corporation, Milpitas, CA (US)

(72) Inventors: Abhishek Tiwari, Kota (IN); Hedong Yang, Santa Clara, CA (US); Xu Zhang, Milpitas, CA (US); Li He, San Jose, CA (US); Rajasekhar Kuppa, Morgan Hill, CA (US); Surajit Mondal, Bankura (IN)

(21) Appl. No.: 18/918,006

(22) Filed: Oct. 16, 2024

Related U.S. Application Data
(60) Provisional application No. 63/705,509, filed on Oct. 10, 2024.

(30) Foreign Application Priority Data
Aug. 28, 2024 (IN) 202441064962

(51) Int. Cl. G06V 10/98; G06T 7/00; G06V 10/25

(52) U.S. Cl. CPC G06V 10/993; G06T 7/001; G06V 10/25; G06T 2207/20076; G06T 2207/30148

(57) ABSTRACT

Methods and systems for determining a signal-to-noise metric for locations of interest on a specimen are provided. One or more statistics of non-defect signals from background patch images in a test image that are similar to a patch image of a location of interest in the test image are determined. The background patch images are found by searching a reference image for patch images that are similar to the location of interest patch image and finding the corresponding patch images in the test image. The signal of the location of interest in the test image and the one or more statistics are used to determine a signal-to-noise metric for the location of interest. The signal-to-noise metric can be used in applications such as defect annotation, deep learning (DL) model tunability, DL model repeatability, and novel defect detection.

### BACKGROUND OF THE INVENTION

### 1. Field of the Invention

The present invention generally relates to methods and systems for determining a signal-to-noise metric for locations of interest such as detected defect locations on a specimen. Certain embodiments described herein relate to methods and systems for defect annotation guidance, deep learning (DL) model tunability, DL model robustness, and novel defect detection based on the signal-to-noise metric.

### 2. Description of the Related Art

The following description and examples are not admitted to be prior art by virtue of their inclusion in this section.

Fabricating semiconductor devices such as logic and memory devices typically includes processing a specimen such as a semiconductor wafer using a number of semiconductor fabrication processes to form various features and multiple levels of the semiconductor devices. For example, lithography is a semiconductor fabrication process that typically involves transferring a pattern to a resist arranged on a semiconductor wafer. Additional examples of semiconductor fabrication processes include, but are not limited to, chemical-mechanical polishing, etch, deposition, and ion implantation. Multiple semiconductor devices may be fabricated in an arrangement on a semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Methods and systems configured for performing the yield related processes described above are often developed by first finding the best possible hardware configuration for generating images, data, measurements, signals, etc. for the specimens. Once the hardware configuration has been established, parameters of the hardware that are best for the processes are selected. Hardware parameter selection can greatly affect how responsive the images, data, measurements, signals, etc. are to the specimen and how well they can be used for determining information for the specimen.

Hardware parameter selection is often followed by (or performed concurrently with) software parameter selection, or more generally selection of any parameters of any methods performed on or with the output of the hardware, which may include any parameters of any algorithms used by such methods. One difficulty that often arises during either or both of these steps is finding images of suitable examples of defects (or other specimen structures) that can be used to train the methods or algorithms. The finding and labeling of such image examples may be generally referred to as annotation, and currently such annotation is usually performed manually by examining defect signal strength based on a visual assessment. Once suitable examples are found and annotated they may be used as a training data set for training or tuning the methods or algorithms and for ensuring that the methods or algorithms can meet a predetermined repeatability.

There are however a number of important disadvantages to the methods and systems currently used for applications described above. For example, with respect to annotation, the best known method (BKM) provided to a user is to annotate only relatively strong defects for optimal capture rate and nuisance rate. However, visual assessment of relatively strong/relatively subtle defects is not reliable. For example, different people can have different opinions on what is a strong defect. In addition, even when information for a defect of interest (DOI) is available for defect annotation, it can still be difficult to find good DOI examples in inspection images or to know which detected events are DOIs and which are not. In this manner, data annotation can be difficult and subjective. Therefore, a quantitative measurement that can advantageously guide user annotation towards stable performance would be useful.

With respect to DL model tunability, a user may tune a defect detection method or algorithm based on a normalized likelihood ratio (NLR) score output by a DL model. However, such DL model output does not correlate well with defect signal strength. For example, the expectation may be that stronger defect signals will have higher model output. However, in some cases, a relatively weak defect can have a higher model output than a relatively strong defect. Since the NLR score does not correlate with defect strength, a user cannot tune the NLR threshold and drop some relatively weak defects in detection. In this manner, currently used DL methods and systems have inadequate tunability of DL model output for defects filtering. This inability to adequately tune a DL model is a major challenge that can prevent DL adoption.

DL models can also suffer from run-to-run detection/classification repeatability issues. For example, another major challenge in DL based defect detection is lack of repeatability across different captures of the same wafer. In particular, using the same DL detection model on images generated with different scans of one wafer can produce a different defect count each time, making it difficult for users to monitor the trend objectively. DL repeatability can also be particularly problematic for some defects like relatively subtle defects. Consistent repeatability of detected defects is crucial for ensuring reliable and accurate identification of defects and is an important element of model robustness.

Any detection/classification method or algorithm can also suffer from issues related to novel defect detection/classification. For example, if a DL detection/classification model is not trained with examples of a novel defect type, DL detection may miss the defect. Novel and misclassified defects can thereby pollute other defect bins such as SEM non-visual (SNV) defect bins. Missing novel defects is generally not acceptable to users and can prevent them from adopting a DL model. In addition, if a satisfactory way to find and classify novel defects cannot be found, then the only way to achieve that is by manual operator review of either or both of defects and non-defects identified via inspection and review. Obviously, such manual novel defect identification is less than optimal for a number of reasons such as the user time involved and the subjectivity of such manual processes.

Accordingly, it would be advantageous to develop systems and methods for determining a signal-to-noise metric for locations of interest on a specimen such as detected defect locations that can be used in applications described above that do not have one or more of the disadvantages described above.

### SUMMARY OF THE INVENTION

The following description of various embodiments is not to be construed in any way as limiting the subject matter of the appended claims.

One embodiment relates to a system configured for determining a signal-to-noise metric for locations of interest on a specimen. The system includes an imaging subsystem configured for generating images of a specimen. The system also includes a computer subsystem configured for finding a location of interest in the images of the specimen and acquiring a test image and a reference image for the location of interest. The computer subsystem is also configured for finding patch images in the reference image that are similar to a patch image in the test image at the location of interest. In addition, the computer subsystem is configured for identifying candidate patch images in the test image at locations of the found patch images and eliminating any of the identified candidate patch images containing defect pixels thereby generation a population of background patch images in the test image. The computer subsystem is further configured for calculating one or more statistics of non-defect signals from the population of background patch images and calculating a signal-to-noise metric for the location of interest from a signal for the location of interest in the test image and the one or more statistics. The system may be further configured as described herein.

Another embodiment relates to a computer-implemented method for determining a signal-to-noise metric for locations of interest on a specimen. The method includes the finding a location of interest, acquiring, finding patch images, identifying, eliminating, calculating one or more statistics, and calculating a signal-to-noise metric steps performed by the computer subsystem as described above. Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for determining a signal-to-noise metric for locations of interest on a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a schematic diagram illustrating examples of defect and reference images and one embodiment of steps performed for determining a signal-to-noise metric for a defect detected on a specimen using the images;

FIG. 4 is a flow chart illustrating one embodiment of steps performed for determining a signal-to-noise ratio (SNR) metric for defects detected on a specimen;

FIG. 5 is a flow chart illustrating one embodiment of steps performed for annotation guidance and deep learning (DL) model tunability;

FIG. 6 is a flow chart illustrating one embodiment of steps performed for DL model tunability;

FIG. 7 is a flow chart illustrating one embodiment of steps performed for DL model repeatability;

FIG. 8 is a plot illustrating one example of a relationship between repeatability and SNR metric values;

FIG. 9 is a flow chart illustrating one embodiment of steps performed for novel defect detection;

FIG. 10 is a schematic diagram illustrating example defect and non-defect images and one embodiment of steps performed for novel defect detection; and

FIG. 11 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are configured for determining a signal-to-noise metric for locations of interest on a specimen. The locations of interest may include locations of defects or non-defects on the specimen (events detected on the specimen that are not defects). The embodiments described herein may be performed most often for such locations of interest since the embodiments are particularly advantageous for applications such as inspection and defect review. However, the locations of interest may include other locations such as a location of a patterned feature formed on the specimen that is being measured during a metrology process. Although some embodiments may be described herein with respect to locations of interest that are locations of defects, non-defects, or defects of interest (DOI), all of the embodiments may be used for any other locations of interest on specimens such as those described herein.

Deep learning (DL) algorithms and models have demonstrated superior performance in tasks such as defect detection and classification. However, some disadvantages to currently used DL models include that images can be hard to annotate, the DL models can be hard to tune (e.g., DL score/output does not correlate with defect strength), the DL models may not be repeatable, and the DL models may miss novel defects. These disadvantages can prevent users from trusting and adopting DL based detection and classification models. The embodiments described herein overcome such disadvantages by providing a novel patch similarity-based signal-to-noise ratio (SNR) score (also referred to herein as a “signal-to-noise metric,” “SNR,” and “SNR attribute”) that can be used for the applications described herein.

Intuitively, SNR is the most straightforward measurement related to defect strength/saliency. However, relatively simple calculations, e.g., comparing defective pixels with surrounding background pixels, may not be reliable. In particular, calculating SNR in this manner may not have a relatively good correlation with defect strength. The embodiments described herein propose a new way to calculate or estimate SNR score based on patch similarity.

The SNR calculations described herein are advantageous because they adapt the computation to data distribution and correlate well with the perceived (visual) defect signal strength. As described further herein, background noise statistics may be estimated based on searched similar regions. The SNR score may then be computed with respect to the estimated background noise statistics. Although the SNR calculations described herein are more compute heavy than the simpler, previously used methods, there are relatively simple ways to mitigate that if needed, e.g., using a graphics processing unit (GPU) to accelerate computation to meet throughput requirements.

The novel SNR metric provided by the embodiments described herein can be used in novel ways for annotation guidance, DL model tunability and robustness. In one such example, the SNR metric can be used to guide a user defect annotation process and create standardized best known methods (BKMs). For example, the BKMs may be created by evaluating the SNR approach on a variety of datasets. Then, the BKMs can be used to identify what range of SNR defects should be deleted, modified, or retained on any newer data. In addition, the signal-to-noise metric can be used to guide users to annotate only relatively strong defects (e.g., so that a user only annotates defects having an SNR greater than, for example, 3).

The signal-to-noise metric can also be used to improve DL robustness. In particular, the signal-to-noise metric described herein can be used to tune DL models better than DL model output, since the SNR score is correlated with defect strength while DL scores are not. In addition, the SNR metric described herein can be used to provide DL model repeatability that meets user specifications. In one such example, defects having an SNR greater than, for example, 3, may have 90% repeatability from run-to-run. Furthermore, the embodiments described herein can be configured to catch novel defects based on the new SNR score, which may include novel defects that a DL model missed.

The embodiments described herein are also advantageous in that they can be used with different types of tools including those described further herein. The SNR score can also be calculated and used in both training phases or tools and on tool during runtime. In addition, the SNR score can be made available to a user for annotation and results viewing (e.g., on a training station) and on the main user interface (UI) in runtime (e.g., on-tool).

“Nuisances” (which is sometimes used interchangeably with “nuisance defects”) as that term is used herein is generally defined as defects that a user does not care about and/or events that are detected on a specimen but are not really actual defects on the specimen. Nuisances that are not actually defects may be detected as events due to non-defect noise sources on a specimen (e.g., grain in metal lines on the specimen, signals from underlaying layers or materials on the specimen, line edge roughness (LER), relatively small critical dimension (CD) variation in patterned attributes, thickness variations, etc.) and/or due to marginalities in the inspection system itself or its configuration used for inspection.

The term “defects of interest (DOIs)” as used herein is defined as defects that are detected on a specimen and are actual defects on the specimen. Therefore, the DOIs are of interest to a user because users generally care about how many and what kind of actual defects are on specimens being inspected. In some contexts, the term “DOI” is used to refer to a subset of all of the actual defects on the specimen, which includes only the actual defects that a user cares about. For example, there may be multiple types of DOIs on any given specimen, and one or more of them may be of greater interest to a user than one or more other types.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

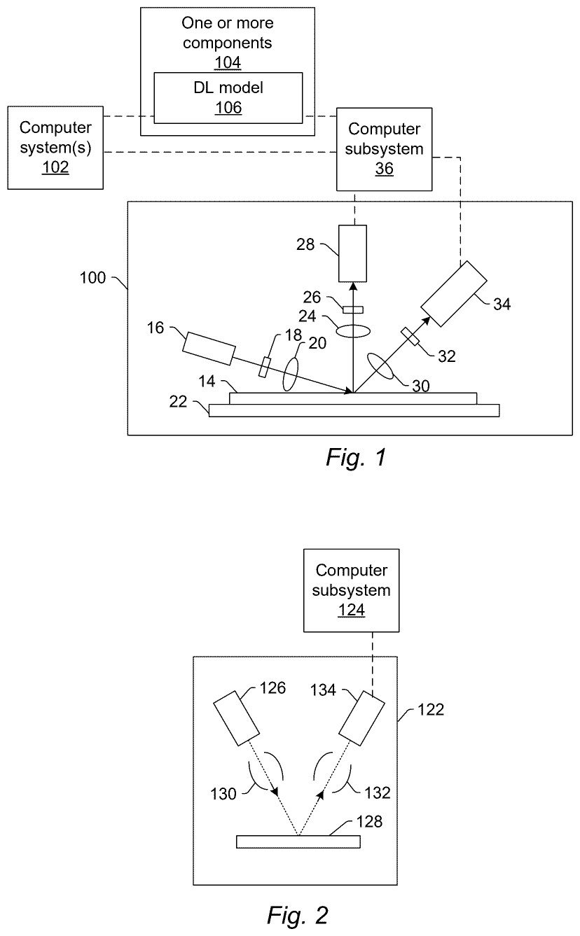

One embodiment of a system configured for determining a signal-to-noise metric is shown in FIG. 1. The system includes imaging subsystem 100 configured for generating images of the specimen. In FIG. 1, the imaging subsystem is configured as a light-based imaging subsystem. However, the imaging subsystem may be configured as an electron beam or charged particle beam based imaging subsystem.

In general, the imaging subsystems described herein include at least an energy source and a detector. The energy source is configured to generate energy that is directed to a specimen. The detector is configured to detect energy from the specimen and to generate output responsive to the detected energy.

In a light-based imaging subsystem, the energy directed to the specimen includes light, and the energy detected from the specimen includes light. For example, as shown in FIG. 1, the imaging subsystem includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the defects to be detected on the specimen.

The illumination subsystem may be configured to direct the light to the specimen at different angles of incidence. For example, the imaging subsystem may be configured to alter one or more parameters of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for imaging.

The imaging subsystem may also include a scanning subsystem configured to change the position on the specimen to which the light is directed and from which the light is detected and possibly to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging subsystem may be configured such that one or more optical elements of the imaging subsystem perform some scanning of the light over the specimen such that the light can be directed to and detected from different positions on the specimen. The light may be scanned over the specimen in any suitable fashion such as in a serpentine-like path or in a spiral path.

The imaging subsystem further includes one or more detection channels. At least one of the detection channel(s) includes a detector configured to detect light from the specimen due to illumination of the specimen by the system and to generate output responsive to the detected light. The imaging subsystem shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging subsystem that includes two detection channels, the imaging subsystem may include a different number of detection channels (e.g., only one detection channel or two or more detection channels). The detection channel formed by collector 30, element 32, and detector 34 may form one side channel as described above, and the imaging subsystem may include an additional detection channel (not shown) formed as another side channel that is positioned on the opposite side of the plane of incidence. Therefore, the imaging subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging subsystem may also include two or more side channels configured as described above. As such, the imaging subsystem may include at least three channels (i.e., one top channel and two side channels), and each of the at least three channels is configured to collect light at different scattering angles than each of the other collectors.

As described further above, one or more of the detection channels may be configured to detect scattered light. Therefore, the imaging subsystem shown in FIG. 1 may be configured for dark field (DF) imaging. However, the imaging subsystem may also or alternatively include detection channel(s) that are configured for bright field (BF) imaging. Therefore, the imaging subsystems described herein may be configured for only DF, only BF, or both DF and BF imaging. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors in each of the detection channels may be signals or data, but not image signals or image data. In such instances, a computer subsystem may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

Computer subsystem 36 may be coupled to the detectors of the imaging subsystem in any suitable manner (e.g., via one or more transmission media, which may include “wired” and/or “wireless” transmission media) such that the computer subsystem can receive the output generated by the detectors. Computer subsystem 36 may be configured to perform a number of functions using the output of the detectors as described further herein. Computer subsystem 36 may be further configured as described herein.

Computer subsystem 36 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 36 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

In an electron beam imaging subsystem, the energy directed to the specimen includes electrons, and the energy detected from the specimen includes electrons. In one such embodiment shown in FIG. 2, the imaging subsystem includes electron column 122, and the system includes computer subsystem 124 coupled to the imaging subsystem. Computer subsystem 124 may be configured as described above. In addition, such an imaging subsystem may be coupled to another one or more computer subsystems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam imaging subsystem may be configured to use multiple modes to generate output for the specimen as described further herein (e.g., with different illumination angles, collection angles, etc.). The multiple modes of the electron beam imaging subsystem may be different in any output generation parameters of the imaging subsystem.

Computer subsystem 124 may be coupled to detector 134 as described above. The detector may detect electrons returned from the surface of the specimen thereby forming electron beam images of (or other output for) the specimen. The electron beam images may include any suitable electron beam images. Computer subsystem 124 may be configured to perform any step(s) described herein. A system that includes the imaging subsystem shown in FIG. 2 may be further configured as described herein.

FIGS. 1 and 2 are provided herein to generally illustrate configurations of an imaging subsystem that may be included in the system embodiments described herein. Obviously, the imaging subsystem configurations described herein may be altered to optimize the performance of the imaging subsystem as is normally performed when designing a commercial imaging system. In addition, the systems described herein may be implemented using an existing imaging system (e.g., by adding functionality described herein to an existing imaging system) such as the tools that are commercially available from KLA Corp., Milpitas, Calif. For some such systems, the methods described herein may be provided as optional functionality of the imaging system (e.g., in addition to other functionality of the imaging system). Alternatively, the imaging system described herein may be designed “from scratch” to provide a completely new imaging system.

Although the imaging subsystem is described above as being a light or electron beam imaging subsystem, the imaging subsystem may be an ion beam imaging subsystem. Such an imaging subsystem may be configured as shown in FIG. 2 except that the electron beam source may be replaced with any suitable ion beam source known in the art. In addition, the imaging subsystem may include any other suitable ion beam system such as those included in commercially available focused ion beam (FIB) systems, helium ion microscopy (HIM) systems, and secondary ion mass spectroscopy (SIMS) systems.

The imaging subsystem may be configured to generate output, e.g., images, of the specimen with multiple modes. In general, a “mode” is defined by the values of parameters of the imaging subsystem used for generating images of a specimen (or the output used to generate images of the specimen). Therefore, modes may be different in the values for at least one of the parameters of the imaging subsystem (other than position on the specimen at which the output is generated). For example, the modes may be different in any one or more alterable parameters (e.g., illumination polarization(s), angle(s), wavelength(s), etc., detection polarization(s), angle(s), wavelength(s), etc.) of the imaging subsystem. The imaging subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

In most implementations of the embodiments described herein, the imaging subsystem may be configured as an inspection subsystem having a configuration that is particularly suitable for defect detection. However, the various embodiments described herein can also be used for applications instead of or in addition to inspection. In particular, the embodiments described herein can be used to calculate SNR in any application in which such calculations are used. The SNR calculations described herein can also be used in applications other than inspection for annotation, DL model tunability, DL model repeatability, and novel defect detection in the same manner as described herein.

In one such example, instead of (or in addition to) an inspection subsystem, the embodiments described herein may include a metrology subsystem or a defect review subsystem. For example, the embodiments of the imaging subsystem shown in FIGS. 1 and 2 may be modified in one or more parameters to provide different imaging capability depending on the application for which it will be used. In one such example, the imaging subsystem may be configured to have a higher resolution if it is to be used for metrology rather than for inspection. In other words, the embodiments of the imaging subsystem shown in FIGS. 1 and 2 describe some general and various configurations for an imaging subsystem that can be tailored in a number of manners that will be obvious to one skilled in the art to produce systems having different imaging capabilities that are more or less suitable for different applications.

In this manner, the imaging subsystem may be configured for generating output that is suitable for re-detecting defects on the specimen in the case of a defect review system and for measuring one or more characteristics of the specimen in the case of a metrology system. In a defect review system embodiment, computer subsystem 124 shown in FIG. 2 may be configured for re-detecting defects on specimen 128 by applying a defect re-detection method to the output generated by detector 134 and possibly determining additional information for the re-detected defects using the output generated by the detector. In a metrology system embodiment, computer subsystem 36 shown in FIG. 1 may be configured for determining one or more characteristics of specimen 14 using the output generated by detectors 28 and/or 34.

As noted above, the imaging subsystem is configured for scanning energy (e.g., light, electrons, etc.) over a physical version of the specimen thereby generating output for the physical version of the specimen. In this manner, the imaging subsystem may be configured as an “actual” subsystem, rather than a “virtual” subsystem. However, a storage medium (not shown) and computer subsystem(s) 102 shown in FIG. 1 may be configured as a “virtual” system. In particular, the storage medium and the computer subsystem(s) may be configured as a “virtual” inspection system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., which are incorporated by reference as if fully set forth herein. The embodiments described herein may be further configured as described in these patents.

In some embodiments, the system includes one or more components executed by the computer subsystem, and the one or more components include a DL model configured as described further herein. Such a system embodiment may or may not also include the imaging subsystem. In this manner, the functions performed by the DL model may be performed on-tool. For example, as shown in FIG. 1, the system may include one or more components 104 executed by computer subsystem 36 (and/or computer system(s) 102), and the one or more components include DL model 106. Computer subsystem 36 (and/or computer system(s) 102) may input images generated for specimen 14 (by imaging subsystem 100 and/or one or more of the computer subsystems) and any other information described herein into the DL model. Output generated by the DL model may then be sent to computer subsystem 36 (and/or computer system(s) 102). The computer subsystem may then be configured for performing one or more functions described herein with the DL model output.

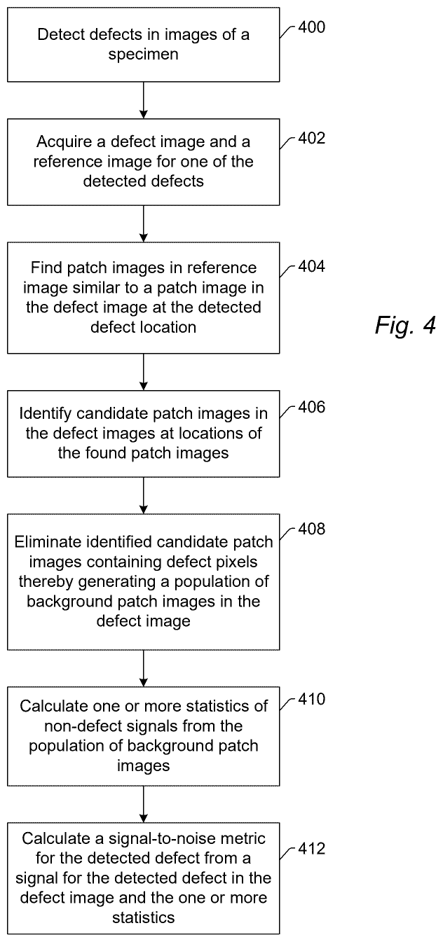

The computer subsystem is configured for finding a location of interest in the images of the specimen and acquiring a test image and a reference image for the location of interest. For example, in the case of inspection, the location of interest may be a location of a defect detected on a specimen, and the test image may be a defect image generated for the detected defect. In this manner, finding the location of interest in the images may include detecting defects in the images of the specimen, as shown in step 400 of FIG. 4, and acquiring a test image, in this case a defect image, and a reference image for at least one of the detected defects, as shown in step 402.

The computer subsystem may be configured for acquiring these images using an imaging subsystem configured as described herein. The computer subsystem may alternatively acquire the images from a storage medium in which they have been stored or from another method or system that generates the images. In this manner, the computer subsystem may acquire the images by retrieving or receiving them from another method or system. Therefore, one system may generate the images described herein, and the system described herein may detect defects in the images and perform other steps with the images as described further herein. However, one system may be configured for performing all of these functions.

Detecting the defects in the images may be performed in any suitable manner. For example, in the simplest implementation, the computer subsystem may subtract a reference image from a test image thereby generating a difference image. A threshold may then be applied to the difference image to separate pixels that may be responsive to events (e.g., candidate or potential defects) from non-events (e.g., noise, nuisance, etc.). The defect detection may also be performed using relatively sophisticated defect detection methods and algorithms including some like the multiple die auto-thresholding (MDAT) algorithm that is used by some commercially available inspection systems from KLA Corp., Milpitas, Calif. The defect detection may also be performed using a DL model including any of those described in the references incorporated herein. Any other suitable defect detection method or algorithm known in the art may also be used for the defect detection step.

Once the defects have been detected, the computer subsystem may acquire a defect image and a reference image for each detected defect. The defect image will generally be the test image generated by the imaging subsystem in which the defect was detected. The size and other characteristics of the defect image may vary depending on the imaging subsystem configuration and the defect detection method or algorithm used to detect the defects. The reference image may be a different, corresponding image of the specimen (like an image for a different cell, field, die, etc. depending on the type of inspection being performed) generated by the imaging subsystem. The reference image may alternatively be an image generated from multiple specimen images (as in a computed reference image) or an image generated without the specimen (as in a reference image generated from a design for the specimen for die-to-database type inspection). The reference image ideally does not have any defects or is defect free (or made to be this way). This image may also vary depending on the specimen, the imaging subsystem configuration, and the defect detection algorithm.

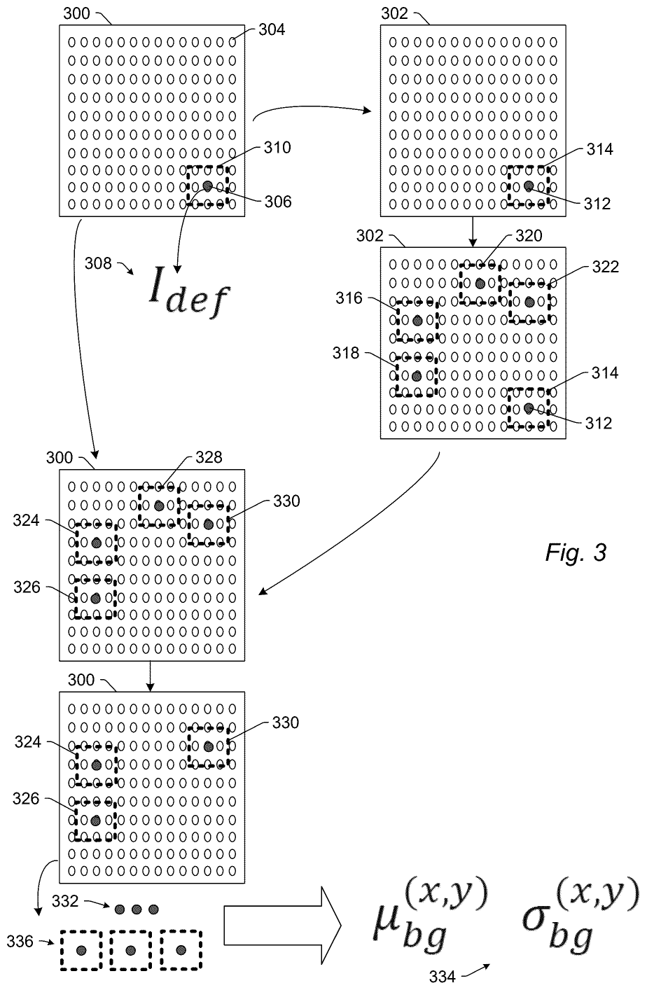

One important new feature of the embodiments described herein is patch similarity based SNR score. FIG. 3 schematically shows the steps that may be performed for SNR computation with an example reference-defect images scenario. FIG. 3 shows an example of defect image 300 and reference image 302. These images are not meant to show any actual images that may be generated by the imaging subsystems described herein for any of the specimens described herein. Instead, these images are relatively simple, hypothetical images (shown as black and white line drawings rather than actual gray scale images that would normally be generated by the imaging subsystems described herein) that are included herein only to convey how the embodiments described herein can be performed using such images.

In general, the images show structures 304 formed on the specimen, which may obviously vary depending on the design for the specimen. The defect and reference images may also have a size that varies depending on the configuration of the imaging subsystem used for generating the images and/or the parameters of the method used to detect the defects on the specimen. For example, the defect and reference images may have the same size as a job or frame image size that is used for detecting the defects. Defect image 300 includes an image of at least one defect detected on the specimen, e.g., defect 306. The results of the defect detection method may include intensity 308 of the portion of the defect image corresponding to the defect, I_{def}.

The computer subsystem is also configured for finding patch images in the reference image that are similar to a patch image in the test image at the location of interest. For example, the computer subsystem may find patch images in the reference image that are similar to a patch image in a defect image at a location of one of the detected defects, as shown in step 404 of FIG. 4. The computer subsystem may define patch image 310 in defect image 300 at the location of the one detected defect. Alternatively, such a patch image may be predefined in the results generated by defect detection and acquired by the computer subsystem. The patch image may have any suitable size and may generally (but not necessarily) be rectangular or square in shape. The patch image may also be centered on the location of the detected defect, although that is not necessary.

The location of the detected defect in the defect image may then be translated to the reference image. For example, location 312 in the reference image corresponding to the location of detected defect 306 in the defect image may be output in the inspection results and then acquired by the computer subsystem. If such information is not available in the inspection results, the computer subsystem may find the reference image location that corresponds to the defect location in the defect image by aligning the defect and reference images, which may be performed in a number of suitable manners known in the art, and then identifying the corresponding reference image location based on results of the aligning step. Other methods such as translating the defect location in the defect image to the reference image location using specimen or design coordinates may also be used. Once the defect location is found in the reference image, the intensity of the corresponding location, I_{ref}, may be determined. In addition, the computer subsystem may identify a neighborhood or reference image patch 314 around the location in the reference image corresponding to the defect location. The patch images in the defect and reference images may generally be defined to have the same shape and size although that is not necessary.

As shown in FIG. 3, the computer subsystem may then find patches 316, 318, 320, and 322 in reference image 302 that are similar to patch 314. The patches in the reference image that are similar to patch image 314 at reference image location 312 corresponding to the defect location in the defect image may be found using any suitable method or algorithm such as template-matching with sum of squared differences (SSD) and normalized cross-correlation (NCC). Such methods may generate output that is responsive to how similar two different image portions are to each other. The computer subsystem may also threshold the output of such methods to determine which image patches may be considered similar to each other for the purposes described herein. For example, the computer subsystem may threshold NCC results to separate image portions that are similar enough to patch 314 for the purposes described herein from other image portions. In addition, the patches that are identified as similar to the reference image patch at the defect location may be identical to the reference image patch but do not need to be identical for determining the background image statistics for the embodiments described herein.

The computer subsystem is further configured for identifying candidate patch images in the test (e.g., defect) image at locations of the found patch images, as shown in step 406 of FIG. 4. For example, the computer subsystem may map the locations of patches 316, 318, 320, and 322 in the reference image to locations in the defect image thereby defining patches 324, 326, 328, and 330, respectively, in defect image 300 (the same defect image in which the defect was detected). Mapping the reference image patches to the defect image may be performed as described further above, e.g., using image alignment results and/or coordinate translations.

The computer subsystem is also configured for eliminating any of the identified candidate patch images containing defect pixels thereby generating a population of background patch images in the test (e.g., defect) image, as shown in step 408 of FIG. 4. For example, as shown in FIG. 3, the background patch images remaining after eliminating candidate patch images containing defect pixels may include patch images 324, 326, and 330, but not patch image 328. Filtering out the patches in the defect image containing defect pixels may be performed in any suitable manner. For example, the computer subsystem may use the inspection results to determine if there are any defects detected within the candidate patches. The computer subsystem may alternatively perform some defect detection method on the candidate patches to determine if any of them contain defect pixels. The defect detection method used for this step may include any suitable defect detection method known in the art or described further herein.

The computer subsystem is further configured for calculating one or more statistics of non-defect signals from the population of background patch images, as shown in step 410 of FIG. 4. For example, the statistics may include mean

$${μ}_{bg}^{( x , y )} ,$$

and standard deviation,

$${σ}_{bg}^{( x , y )} ,$$

calculated on the background patch images. While mean and standard deviation may be the statistics that would most often be determined by the embodiments described herein, the statistics may include any other suitable statistics known in the art.

Since the background patch images are used for calculating one or more statistics of non-defect signals, a minimum number of the background patch images suitable for this step may vary depending on the statistics that are being determined. At least two background patch images may be enough to calculate statistics such as those described herein, but as the number of background patch images increases, the quality of the determined statistics may be better. As such, it may be useful to set a minimum number of background patch images to use for the statistics calculations, and if enough background patch images cannot be found in a single defect image, the computer subsystem may try to grab background patch images at corresponding locations in other defect images generated in the same inspection of the same specimen. Those background patch images may be identified as described herein and examined for defectivity in the same manner described herein.

Calculating the SNR metric with a reference image may be performed with a pixel-based algorithm. This approach divides the defect into multiple pixels and computes SNR for each pixel. For example, in one embodiment, the one or more statistics include a center pixel mean and standard deviation along patch dimension. In this example, as shown in FIG. 3, the computer subsystem may extract center pixels 332 from background patch images 324, 326, and 330 and use them to determine statistics 334. The patches have spatial dimension (height, width) as well as a number of patches are searched for reliable estimation of background statistics. The patch dimension refers to the number of patches dimension, i.e., for each pixel the mean and standard deviation are estimated across the number of patches dimension. For example, if patch height and width are equal to 11 each, and there are 21 patches, then the patch dimension equals 21.

Calculating the SNR metric with a reference image may alternatively be performed with a patch-based algorithm. This approach divides the defect into multiple patches and computes SNR for each patch. For example, in another embodiment, the one or more statistics include a per-pixel mean and standard deviation along patch dimension. In this manner, in the embodiment described above, the statistics are computed for only the center pixel in the patch whereas in this embodiment, they are computed for all pixels within the patch. The embodiment that is used for any one use case may be determined based on the estimated reliability for the statistics. For example, if the statistics are expected to only be reliable for the center pixel, then the embodiment described above may be used. In contrast, if the statistics are expected to be reliable for the entire patch region, then the per-pixel statistics may be determined as described in this embodiment. The patch dimension may be defined in this embodiment as described above. In one such example, as shown in FIG. 3, the computer subsystem may extract background patch images 336 for background patch images 324, 326, and 330 in the defect image and use them to determine statistics 334.

The computer subsystem is configured for calculating a signal-to-noise metric for the location of interest from a signal for the location of interest in the test image and the one or more statistics. For example, the computer subsystem may calculate the signal-to-noise metric for at least one of the detected defects from a signal for the at least one of the detected defects in the defect image and the one or more statistics, as shown in step 412 of FIG. 4. For example, in both the pixel-based and the patch-based algorithms, the SNR metric for the detected defect,

$${SNR}_{def}^{x , y} ,$$

may be determined with the following equation:

$${SNR}_{def}^{x , y} = \frac{\vert {I}_{def}^{x , y} - {μ}_{bg}^{x , y} \vert}{{σ}_{bg}^{x , y}} ; ∀ ( x , y ) ∈ defect$$

This SNR equation computes the separability of defect vs. background signal mean as a multiple of background signal variance. The absolute operator in the above equation accounts for brighter and darker defects. In other words, the absolute operator is used to treat the brighter and darker defects similarly with respect to the background. The SNR metric may also be determined using any other suitable equation known in the art.

The SNR metric may be computed in multiple ways for a single defect, and the embodiments described herein may use one or more of the different SNR metrics as described herein, e.g., for annotation, DL model tunability, DL model repeatability, and novel defect detection. In one such example, the SNR metric may be determined for different parameters of the imaging subsystem used to generate different images for the defect. The different parameters may be, for example, different channels of the imaging subsystem that generated images for the specimen. So, the SNR metric may be separately determined for each of the image channels. Different image channels may highlight different signal characteristics and therefore a defect may be separable in only one, a few, or all of the channels. In another example, the SNR metric may be determined across sites on the specimen. For example, in some cases, there may not be enough repetitions of similar patches in a single site. Therefore, it may be helpful to search them across nearby or similar sites for more reliable estimates of background statistics. Furthermore, the SNR metric may be determined with various statistics. Examples of some of such statistics include mean, median, standard deviation, maximum, minimum, inter-quartile range, and the like, each of which may have some statistical significance and are more optimal or robust under certain conditions.

The SNR metric and statistics described above may be computed during on-tool job runs, where the attribute values can be used for improvements such as non-defect class accuracy by filtering novel defects or misclassifications, which may be performed as described further herein. The computed SNR values can also be saved to the lot result as described further herein, which can then be loaded into any suitable software or utilities available on the computer subsystem or another system or method for further analysis/usage.

The SNR metric described herein provides the embodiments described herein and users with a quantitative metric to estimate defect strength with respect to background patterns. For example, SNR captures the discriminability between defect (signal) and background (noise) distributions. As the SNR values increase, the defect discriminability also increases. In addition, as the SNR values decrease, the defect discriminability decreases. As described further herein, the new SNR metric can be used to help remove subjectivity in user annotation, provide tunability for DL detection, improve repeatability for DL detection and classification, and solve novelty type detection issues.

The embodiments described herein primarily provide advantages for the SNR metric because it is a characteristic of a specimen location or defect location that is determined with respect to background signals. In particular, the embodiments described herein provide a new way to determine the background signals for the SNR metric, i.e., as one or more background signal statistics determined from multiple defect-free patch images in the defect image corresponding to the defect patch image. The embodiments described herein may provide similar advantages for other defect or location attribute determinations. For example, for any defect or location attribute that is determined with respect to background signals or images, statistics for the background signals or images may be calculated as described herein and used for such determinations. Any defect attributes or location of interest characteristics determined from the background statistics calculated as described herein may also be used in the same manner as the SNR metrics described herein, e.g., for DL model tunability, defect annotation, etc.

The embodiments described herein may also provide advantages for any defect or location attributes, characteristics, measurements, etc. determined based on the SNR values calculated as described herein. For example, the SNR values calculated as described herein may be used in the same manner as any other SNR values to determine additional defect attributes, to perform one or more measurements at the location of interest, etc. In one such example, the SNR values determined as described herein may be used to estimate defect size in the same manner as SNR values determined by currently used methods and systems. Any of such defect attributes or location of interest characteristics may also be used in the same manner as the SNR metrics described herein, e.g., for DL model tunability, defect annotation, etc.

As mentioned above, an important new feature of the embodiments described herein is that they provide a way to guide user annotation based on SNR score. The performance of learning-based classifiers used in defect detection and classification is completely dependent on example defects. Inconsistent or inaccurate annotations can add an artificial ceiling on the maximum model performance. One significant advantage of the embodiments described herein is that they allow the user to determine which defects should be included in a model training set, so as to achieve the desired performance instead of iterative annotation-train-validate, trial and error kind of methods currently used. In other words, the SNR metric described herein provides a quantitative metric that correlates with defect strength. The SNR metric can be used to eliminate the visual assessment of defect signal strength thereby reducing subjectivity in annotation. The SNR metric can also guide annotation to achieve desired sensitivity for DOIs.

In one embodiment, the locations of interest include locations of defects detected in the images of the specimen, and the computer subsystem is configured for calculating the signal-to-noise metric for a population of the detected defects and generating input to a manual defect annotation method based on the calculated signal-to-noise metric for the detected defects in the population. For example, the computer subsystem may calculate the SNR metric for as many of the detected defects as selected by the computer subsystem or a user, e.g., a predetermined percentage of the defects, all of the defects, etc. The results of the SNR metric calculations may be input to a defect annotation method, system, algorithm, etc. For example, all of the results of the SNR metric calculations may be input to the manual defect annotation method. Alternatively, generating input to the manual defect annotation method may include selecting the defects for annotation based on the SNR metric calculations, which may be performed as described herein.

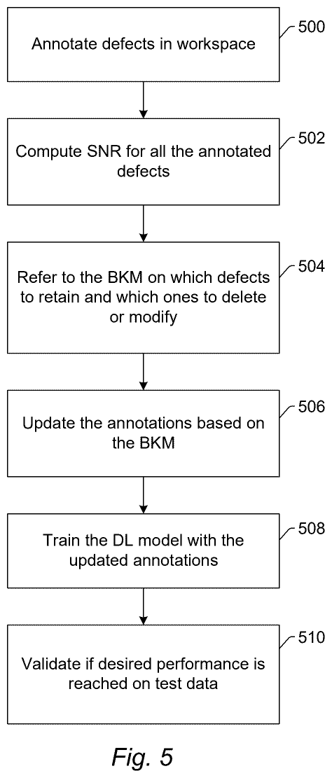

FIG. 5 shows one embodiment of a flow for annotation guidance and DL model tunability. In this embodiment, the SNR metric calculation results may be input to annotate defects in workspace step 500. The annotation performed in this step may be manual (by a user), semi-automated (e.g., performed with some user input or editing), or fully-automated. Manual annotation may be performed with any suitable UI, and using the UI, the user may manually delineate the defect boundary. Semi-automated annotation can be performed in various ways. In one example, a user may click a point on the defect detection results or SNR metric calculation results, and the computer subsystem may delineate a boundary which the user may want to further edit and/or modify. Fully-automated annotation may be generated entirely by the computer subsystem using a model, algorithm, etc. For example, the computer subsystem may input the SNR metric results into a DL model trained on similar data.

The computer subsystem may then compute the SNR for all the annotated defects as shown in step 502. When the SNR metric is computed and input to the defect annotation step, this step may simply include using the already calculated SNR metrics with the results of the annotation step to generate results that include the SNR metrics for the annotated defects. If the annotation step is performed before any SNR metric is calculated, then step 502 may include calculating the SNR metric as described further herein for only the annotated defects.

The computer subsystem may also refer to the BKM on which defects to retain and which ones to delete or modify, as shown in step 504. For example, the BKM may be arrived at by evaluating the SNR approach on a variety of datasets. Specifically, the BKMs tell what range of SNR defects should be deleted, modified, or retained on any newer data in-house or in-field. In step 506, the computer subsystem may update the annotations based on the BKM. In this step, to give one non-limiting example, all of the defects with SNR<2 may be removed, defects with SNR>2 and <3 may be moved to ignore mask (edited) and defects having an SNR>3 may be retained, assuming the BKM tells what SNR defects to delete, modify, or retain.

In one such embodiment, generating the input includes guiding a user to the detected defects in the population having highest values of the calculated signal-to-noise metrics. Guiding annotation performed by a user using the SNR scores determined as described herein can overcome a number of challenges. For example, currently user annotation is an iterative process of annotating defects, validating model performance and repeating until the desired performance is reached. This process can therefore be substantially time and labor intensive, and the number of iterations that have to be performed to achieve the desired performance depends on experience and expertise. However, the embodiments described herein provide a new workflow that may include only annotating strong defects (e.g., SNR greater than a threshold value such as 5). The computer subsystem may collect the data and guide the user to annotate defects of certain strength (SNR greater than a certain predetermined value) based on the BKM, which may be performed as described herein. In one such example, the computer subsystem may display to a user the detected defects having the highest SNR scores as suggested defects and provide means for the user to manually annotate the suggested defects.

The computer subsystem may then train the model to yield the desired performance. In one such embodiment, the computer subsystem is configured for generating a training set of defects based on results of the manual defect annotation method and training a DL model with the training set of defects. For example, as shown in step 508 of FIG. 5, the computer subsystem may train the DL model with the updated annotations. Training the DL model may be performed in any suitable manner. The training may be performed in a supervised manner, since the images that are used for training are annotated as described herein. More generally, training may include inputting the images of the annotated defects into the DL model and modifying one or more parameters of the DL model until the DL model output matches the annotations assigned to the images. Of course, training may be much more complex than this, and the DL model may be trained in any other suitable manner known in the art.

The computer subsystem may also be configured for validating if desired performance of the DL model is reached on test data, as shown in step 510. Validation of the trained DL model may be performed in any suitable manner. The test data may include, for example, a portion of the annotated defects not used for training and set aside for validation. The test data may alternatively include a different population of annotated defects detected on the same specimen or a different specimen of the same type. Generally, validation includes inputting the test data into the trained DL model and comparing the DL model results with the annotations assigned to the test data or other known characteristics of the test data. Once the trained DL model has been validated, it may be released for use.

In one embodiment, the DL model is configured for detecting defects on specimens. In another embodiment, the DL model is configured for classifying defects detected on specimens. The DL model may be further configured as described in commonly owned U.S. Patent Application Publication Nos. 2017/0140524 published May 18, 2017 by Karsenti et al., 2017/0148226 published May 25, 2017 by Zhang et al., 2017/0193400 published Jul. 6, 2017 by Bhaskar et al., 2017/0193680 published Jul. 6, 2017 by Zhang et al., 2017/0194126 published Jul. 6, 2017 by Bhaskar et al., 2017/0200260 published Jul. 13, 2017 by Bhaskar et al., 2017/0200264 published Jul. 13, 2017 by Park et al., 2017/0200265 published Jul. 13, 2017 by Bhaskar et al., 2017/0345140 published Nov. 30, 2017 by Zhang et al. 2019/0073566 published Mar. 7, 2019 by Brauer, and 2019/0073568 published Mar. 7, 2019 by He et al., which are incorporated by reference as if fully set forth herein. In addition, the DL models described herein may have any other suitable architecture and configuration known in the art.

The SNR scores calculated as described herein have demonstrated significant advantages for annotation guidance compared to currently used annotation methods and systems. For example, for annotation guidance, the SNR score provides a quantitative metric with good correlation to defect strength, helps to remove subjectivity in visual assessment of defect strength, and helps to prevent overfitted models. In addition, the SNR score can provide user guidance on identifying defects to include in a training set for tuning DL model performance based on SNR values.

The SNR metric also can be used to guide annotations to achieve desired sensitivity for DOIs. For example, if only relatively strong defects are annotated, the nuisance rate may be advantageously reduced, but the capture rate of DOIs may also be reduced. In contrast, if the annotated defects include both relatively strong and relatively weak defects, the capture rate of DOIs may advantageously be relatively high, but the nuisance rate may also be relatively high. The capture and nuisance rates may be determined using the following equations:

$$Capture Rate = \frac{TP}{TP + FN}$$

$$Nuisance Rate = \frac{FP}{FP + TP + FN}$$

where detected defects when compared with ground truth (manually annotated defects) can fall into one of the following 3 categories: captured (true positive (TP)), missed (false negative (FN)), and nuisance (false positive (FP)).

In an additional embodiment, the locations of interest include locations of defects detected in the images of the specimen, and the computer subsystem is configured for calculating the signal-to-noise metric for a population of the detected defects, generating a training set of defects based on the calculated signal-to-noise metrics for the detected defects in the population, and training a DL model with the training set of defects. For example, the computer subsystem may calculate the SNR metric as described herein for all of the defects detected on the specimen or only a portion of all of the defects detected on the specimen. The computer subsystem may then select some of the defects for annotation based on the SNR metric, which may be performed as described herein. For example, the computer subsystem may select only defects whose SNR metric is greater than or equal to 5. The computer subsystem may then annotate the defects that have been selected. The computer subsystem may annotate the defects using, for example, a known good defect classifier, i.e., a pre-trained defect classifier known to accurately and reliably classify defects detected on specimens similar to the specimen on which the defects have been detected. In this manner, the computer subsystem may be configured for fully automated defect annotation. The computer subsystem may then select a portion of the detected defects to be included in the training set based on the SNR metrics and/or the annotations. For example, the computer subsystem may select defects having only certain values of the SNR metric for inclusion in the training set and/or at least some defects having different annotations for inclusion in the training set. The computer subsystem may then train a DL model with the training set of defects, which may be performed as described further herein. In this manner, the computer subsystem may perform fully automated defect annotation and DL model training guided by the SNR metrics calculated as described herein.

Some embodiments described herein are configured for DL model tunability. One important new feature of the embodiments described herein is that they provide a new way to tune a DL detection and/or classification model using the SNR scores described herein. For example, in some embodiments, the imaging subsystem is configured for generating additional images of an additional specimen, and the computer subsystem is configured for inputting the additional images into a DL model trained to detect defects on the additional specimen, calculating the signal-to-noise metric for locations of a population of the defects detected on the additional specimen by the DL model, and generating inspection results for the additional specimen by applying a threshold to the calculated signal-to-noise metrics for the locations of the defects in the population detected on the additional specimen.

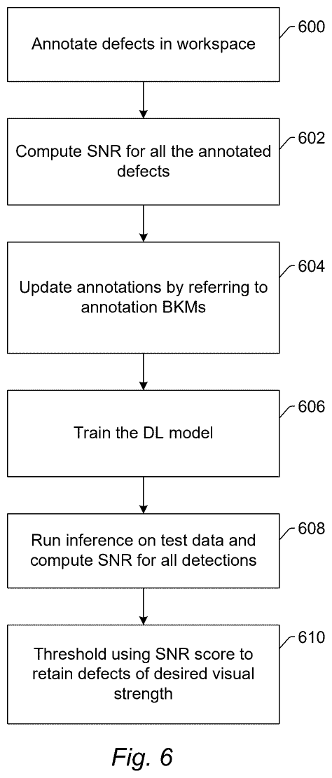

FIG. 6 shows some steps that may be performed in such embodiments. For example, DL model tunability may include annotating defects in workspace, as shown in step 600. This embodiment may also include computing SNR for all the annotated defects, as shown in step 602, and updating the annotations by referring to annotation BKMs, as shown in step 604. In addition, this embodiment may include training the DL model, as shown in step 606. Each of these steps may be performed as described further herein.

DL model tunability may also include running inference on test data and computing the SNR for all detections, as shown in step 608. In this step, the imaging subsystem may generate images of an additional specimen to thereby generate the test data. The imaging subsystem may generate such images as described further herein, and the additional specimen may be the same type of specimen as any setup specimen, e.g., used for training the DL model. For example, the two specimens may be processed in the same fabrication processes and have the same design or devices being fabricated thereon. Running inference on test data performed in step 608 may then include inputting the additional images into a DL model trained for detecting defects. The test data may be input to the trained DL model in any suitable manner by the computer subsystem. The computer subsystem may also compute the SNR metric for all detections in step 608, which may be performed as described further herein.

The threshold that is applied to the calculated SNR metrics for the defects in the population detected on the additional specimen may vary depending on the reason that the threshold is being applied to the defects. For example, in one such embodiment, generating the inspection results includes eliminating the defects in the population detected on the additional specimen having the signal-to-noise metric below the threshold from the inspection results. In such an example, as shown in step 610, the computer subsystem may threshold using SNR score to retain defects of desired visual strength. Such a threshold may be used therefore to retain the defects having the highest SNR values.

The retained defects may then be used for a variety of functions such as analyzing the retained defects (e.g., sampling the defects for defect review and then performing the defect review to classify the sampled defects) and tuning the DL model based on results of the analyzing. Tuning the DL model performance based on the defects retained after thresholding may include altering any one or more parameters of the DL model in the same manner as described above with respect to training until one or more characteristics of the output of the DL model meet or exceed predetermined values. For example, the one or more parameters may be varied until the capture rate, nuisance rate, and/or repeatability of the DL model meets some predetermined criteria, e.g., above a predetermined capture rate, below a predetermined nuisance rate, etc.

The SNR scores calculated as described herein have demonstrated significant advantages for DL model tunability compared to currently used model tuning methods and systems. For example, the computer subsystem may be configured to perform DL model tunability using the SNR score as a metric to filter out defects with desired signal strength. The SNR score provides a quantitative metric with better correlation with defect strength for tunability compared to normalized likelihood ratio (NLR).

As described above, the SNR metric may be applied to the output of the DL model, e.g., to threshold using SNR score to retain defects of desired visual strength. In some instances, the SNR score may also or alternatively be input to the DL model as a channel of information in addition to any of the other input to the DL model described herein, e.g., a defect image, a reference image, etc. In this manner, the SNR scores determined as described herein may be used in the same manner as any other defect attribute, result, characteristic, etc. by the DL model or any other defect classification, re-detection, analysis, etc. method or algorithm.

Some embodiments are configured for improving a performance metric of a DL model. For example, in another embodiment, the computer subsystem is configured for determining one or more parameters of the imaging subsystem used for generating the images based on a relationship between the signal-to-noise metric and an inspection performance metric, and training a DL model with results generated for the specimen or an additional specimen with the images generated with the determined one or more parameters. Determining the one or more parameters of the imaging subsystem may be performed as described below. Although some embodiments are described herein with respect to repeatability of the DL model as the inspection performance metric, the embodiments may be performed in similar ways for other performance metrics such as DOI capture rate, nuisance suppression/capture rate, DL classification accuracy, etc. Training the model in these embodiments may be performed in the same manner as in other embodiments described herein. The results used to train the DL model may also include any results generated for any one or more of the specimens described herein, which may include one or more training specimens, one or more runtime specimens, or other specimens. The DL model whose performance metric is improved in the embodiments described herein may include any of the DL models described further herein.

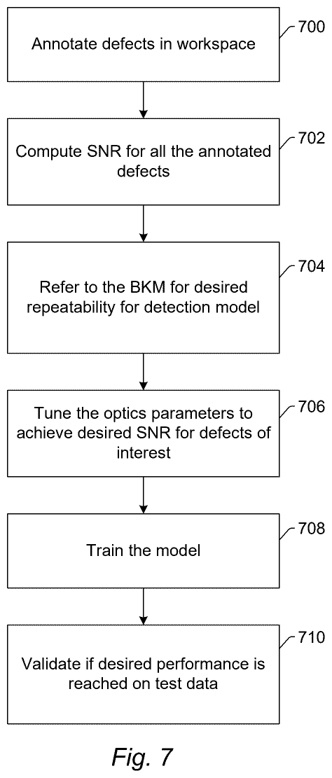

FIG. 7 shows some steps that may be performed in such embodiments. For example, DL model performance enhancement may include annotating defects in workspace, as shown in step 700. This embodiment may also include computing SNR for all the annotated defects, as shown in step 702. Each of these steps may be performed as described further herein.

Such an embodiment may be configured for DL model repeatability for detection an/or classification. For example, a current challenge of some DL models is that they can have non-repeatable detections across multiple inspections/image captures of the same wafer. The SNR metric described herein may however be used to overcome this challenge. For example, in one such embodiment, the signal-to-noise metric in the relationship is the signal-to-noise metric for locations of DOIs on the specimen or the additional specimen, and the inspection performance metric is a repeatability for the DL model. Repeatability captures how many defects are common across two instances of an inspection of the same specimen, i.e., a run-to-run repeatability on the same specimen. Repeatability may be quantified using the following equation:

$${Repeatability}_{SNR = x} = \frac{{d}_{1} ( SNR \geq x ) ⋂ {d}_{2} ( SNR \geq x )}{{d}_{1} ( SNR \geq x ) ⋃ {d}_{2} ( SNR \geq x )}$$

where d₁ is the number of defects detected in a first capture, and d₂ is the number of defects detected in a second capture. The intersection operation in the numerator determines the number of common defects. The union operation in the denominator determines the number of all detected defects (i.e., sum of common, capture 1 unique and capture 2 unique defects). The SNR≥x term in the equation considers defects with a certain SNR range when computing the repeatability number. The SNR value used in this equation may be determined as described herein, and repeatability may be examined for as many different values of the SNR value as appropriate.

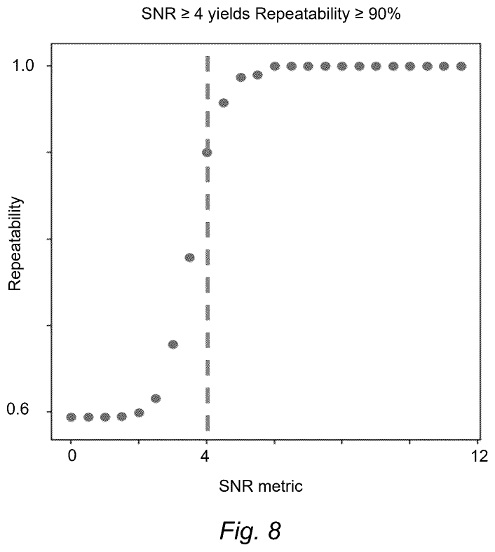

As shown in step 704, the computer subsystem may be configured for referring to the BKM for desired repeatability for the detection model. For example, BKMs may be arrived at by quantifying the repeatability versus defect SNR plot over a variety of datasets. One example of such a plot is shown in FIG. 8. In particular, FIG. 8 shows a plot of repeatability as a function of the SNR metric calculated as described herein for 1000 defect images. Such a plot may be used to determine what values of the SNR metric can provide the desired repeatability values. For example, as shown in FIG. 8, an SNR greater than or equal to 4 yields a repeatability of greater than or equal to 90%. Currently, a 90% repeatability is generally acceptable in the art although, of course, even higher repeatabilities would also be acceptable. The repeatability may also vary depending on the type of specimen and inspection and can be preselected by a user. For example, the SNR metric described herein enables a user to predetermine that SNR>a threshold (such as 5) will have a required repeatability (such as 90%). Without the BKM, a characterization of a newer dataset may be performed to arrive at such a plot.

The SNR metric determined as described herein can be used to determine the need for optics tuning using repeatability vs. SNR plots such as that shown in FIG. 8. In one such embodiment, determining one or more parameters of the imaging subsystem used for generating the images includes modifying the one or more parameters until the signal-to-noise metric calculated for the locations of the DOIs detected on the specimen or the additional specimen with the images generated with the modified one or more parameters is greater than or equal to a value of the signal-to-noise metric corresponding to a predetermined value of the repeatability. For example, as shown in step 706, the computer subsystem may tune the optics parameters to achieve the desired SNR for defects of interest. In one such example, based on a repeatability vs. SNR plot such as that shown in FIG. 8, it is evident that the higher the SNR, the higher the repeatability. Thus, if for DOIs detected with test data, a method or system is not able to achieve the desired repeatability, the image generation parameters can be tuned to increase the SNR thereby increasing the repeatability.

Tuning the image generation parameters until the desired SNR is achieved for the DOIs may be performed in any suitable manner known in the art. For example, the computer subsystem or a user may determine what imaging subsystem hardware parameters can or should be tuned based on the image formation model of the imaging subsystem. Such hardware parameters may include any of those described further above that can be modified, as for different modes of the imaging subsystem.

In such an embodiment, the computer subsystem may be further configured for training the model, as shown in step 708, and validating if desired performance is reached on test data, as shown in step 710, both of which may be performed as described further herein. The desired performance may mainly include, but is not limited to, evaluation metrics such as sensitivity, repeatability, and generalizability. In general, the computer subsystem may try to make sure that all the specifications are met to reach the desired performance criteria.

The SNR scores calculated as described herein have demonstrated significant advantages for quantifying a performance metric such as repeatability of DL models compared to currently used methods and systems. In particular, the SNR scores described herein have a good correlation with repeatability. For example, the SNR scores provide a quantitative metric to characterize repeatability for defects with varying visual strength/discriminability. In other words, variations in inspection results from run-to-run may be caused by defects that exhibit different signals from run-to-run, which can thereby reduce the repeatability of the DL model. The SNR scores described herein however provide a new way to quantify defect detection repeatability across wafer acquisitions. In addition, the SNR scores provide feedback on system optics tuning to reach desired repeatability specifications.

Additional embodiments described herein may be configured for novel defect detection. An important new feature of the embodiments described herein is that they provide a new way to catch novel defects using the SNR scores described herein. In addition, the SNR metrics described herein enable detection of novel defects, misclassified defects, and separating such defects from true non-visual defects. For example, a current challenge of some DL models is that novel and misclassified defects may end up polluting the scanning electron microscope (SEM) non-visual (SNV) (non-defect) bin. The SNR metric described herein may however be used to overcome this challenge. In particular, as described further herein, the SNR metric values may be used to filter out novel and misclassified defects.

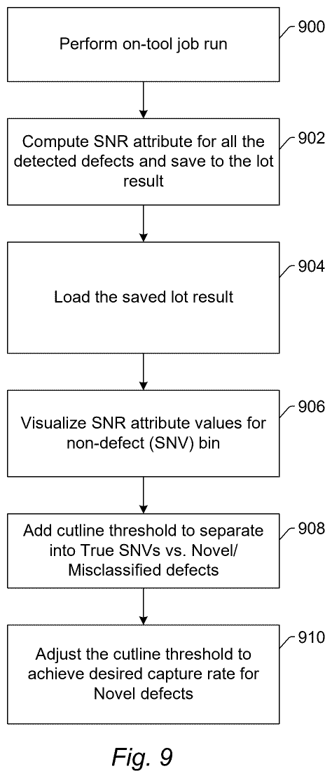

In one such embodiment, the locations of interest include locations of non-defects detected in the images of the specimen, the computer subsystem is configured for finding the locations of the non-defects by detecting events in the images generated of the specimen and separating the detected events into detected defects and the non-defects, and the computer subsystem is configured for calculating the signal-to-noise metric for the locations of a population of the non-defects and applying a threshold to the calculated signal-to-noise metrics for the locations of the non-defects in the population to thereby separate the non-defects that are true non-defects from the non-defects that are actual defects. One such embodiment is shown in FIG. 9. In this embodiment, the computer subsystem may perform an on-tool job run, as shown in step 900. Generally, this step may include generating images for the specimen with the imaging subsystem as described herein and then detecting events on the specimen as described herein (e.g., inputting the imaging subsystem output into one of the DL models described herein). The computer subsystem may also compute the SNR attribute for all the detected defects (and other events) and save to the lot result, as shown in step 902, which may be performed as described further herein. The computer subsystem may further load the saved lot result, as shown in step 904, which may be performed in any suitable manner known in the art. In this step, the computer subsystem may load the saved lot result into any suitable classification or other software that can be used to perform additional steps described herein.

As shown in step 906, the computer subsystem may also visualize the SNR attribute values for the non-defect (SNV) bin. In this step, the software into which the saved lot result is loaded may load the data that contains the SNR attribute values for various detected defects, some of which are SNVs. The values may then be plotted in the software. For example, the software may be configured for generating bar charts for max or mean values of the SNR determined for defects. Such charts may also be generated for different parameters, e.g., detection channel, polarization, etc., of the imaging subsystem used to generate different images of the same detected event. Such charts may therefore help the user to visualize how the SNR values vary for different kinds of defects. In addition, the computer subsystem or software may display the SNR attributes for the detected defects in any other manner that is suitable for conveying this information to a user.

As shown in step 908, the computer subsystem may also add a cutline threshold to separate the detected defects into true SNVs versus novel and/or misclassified defects. A user may add the cutline threshold manually (by visualizing the attributes plot) or using an automated algorithm (classifier or heuristic based) performed by the embodiments described herein, which can then be manually edited. In a further such embodiment, the computer subsystem is configured for altering the threshold based on a predetermined capture rate for the actual defects. For example, as shown in step 910, the computer subsystem may adjust the cutline threshold to achieve the desired capture rate for novel defects.

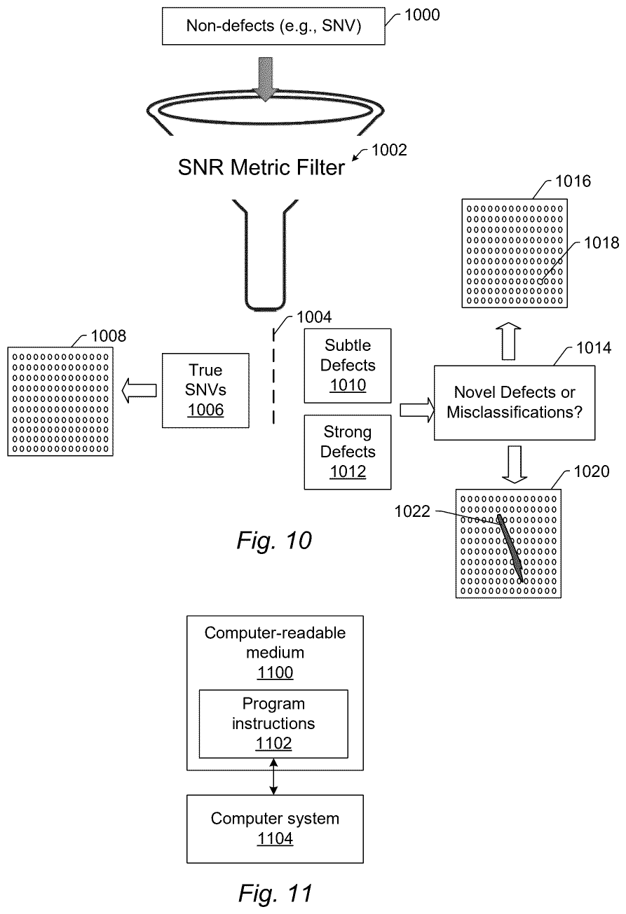

In one such embodiment, the true non-defects include defects that are not visible to the imaging subsystem (i.e., true SNV defects). In another such embodiment, the actual defects include novel defects or misclassified events. FIG. 10 schematically illustrates the steps that may be performed in FIG. 9 to separate true SNVs and novel and misclassified events. FIG. 10 also schematically illustrates examples of true SNVs and novel and misclassified events using the same type of non-limiting example specimen images shown in FIG. 3.

As shown in FIG. 10, the computer subsystem may input non-defects (e.g., SNVs) 1000 into SNR metric filter 1002. The input non-defects may include true SNVs, misclassified defects, and unseen novel defects. The SNR metric filter may be configured to apply cutline threshold 1004 (shown here schematically and not quantitatively) to the SNR metric values of the non-defects to thereby separate the non-defects into true SNVs 1006, subtle defects 1010 and strong defects 1012. One non-limiting example of a suitable cutline threshold value may be 2 or 3, with non-defects having an SNR value below that cutline threshold value separated into true SNVs 1006, and defects having an SNR value above that cutline threshold value separated into subtle defects 1010 and strong defects 1012. The computer subsystem may apply one or more additional thresholds to the non-defects having SNR metric values above the value of cutline threshold 1004 to separate that defect population into the subtle and strong defects. For example, an additional threshold of 10 may be applied to the non-defects that have SNR metric values above cutline threshold 1004. The defects having an SNR metric value between 3 and 10 may then be output in a subtle defect bin, and defects having an SNR metric value above 10 may be output in a strong defect bin.

The computer subsystem may also determine if the subtle and strong defects that are not true SNVs are novel defects or misclassifications. Image 1008 shows one example of a true SNV non-defect in which no defect is visible. Image 1016 shows one example of a specimen image containing subtle defect 1018, which is a relatively small variation in the shape and size of one of the patterned features in that image. Image 1020 shows one example of a specimen image containing strong defect 1022, which schematically represents different kinds of possible defects such as a relatively large foreign or residual material type defect or a large area of missing material such as may be caused by a scratch on the specimen.

The SNR scores calculated as described herein have demonstrated significant advantages for novel defect detection compared to currently used methods and systems. For example, the computer subsystem can detect novel defects or misclassifications in a non-defects (SNV) bin using the SNR score metric.

In any of the embodiments described herein, the computer subsystem may use a graphical user interface (GUI) to perform one or more of the functions described herein, to display results or information to a user, and to receive input from the user. Editing, annotation, and training features described herein may be provided to and accessed by a user with such a GUI. In addition, a user can use the GUI to view images, compute the SNR metric statistics, and to view the performance of each classifier on various datasets.

None of the applications described herein in which the SNR metric can be used are mutually exclusive of any of the other applications described herein. For example, the same SNR metrics can be used as described herein for improved defect annotations, reliable and repeatable model performance, and unsupervised identification of novel defect classes.

Although the embodiments are described herein with respect to DL models and are particularly advantageous for DL models and promoting their usage in the field, the embodiments are not limited to DL models. For example, the embodiments described herein may provide benefits to other types of defect detection and/or classification methods or algorithms. In particular, the SNR metric described herein may be used to improve other types of methods and algorithms in the same ways described herein. In one such embodiment, the SNR metrics calculated as described herein may be used for defect annotation, detection repeatability improvements, detection tuning, and novel defect detection in other algorithms like the MDAT algorithm even if such algorithms do not have the same challenges as DL models.

The computer subsystem may generate results, which may include the results of any of the steps described herein. The computer subsystem may be configured for storing the results in any suitable computer-readable storage medium. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc.

The results may include the SNR metric values calculated as described herein, the defect annotation results generated as described herein, the trained DL model, defect detection and/or classification results generated with the trained DL model, any other defect detection and/or classification results generated as described herein, or any other information generated by the embodiments described herein. The results may be generated by the computer subsystem in any suitable manner. The results may have any suitable form or format such as a standard file type. The computer subsystem may generate the results and store the results such that the results can be used by the computer subsystem and/or another system or method to perform one or more functions with the DL model and/or to perform one or more functions with results generated by the DL model. For example, the DL model (or its file name and location) may be stored in a recipe such as an inspection recipe so that it can be used for detecting defects on a specimen and/or classifying defects detected on the specimen. In such situations, the computer subsystem may be configured for creating a new inspection recipe or modifying an existing inspection recipe.

In another example, the defects detected by any of the embodiments described herein may be stored in a lot results file so that they can be used for one or more other functions described herein. In such instances, the computer subsystem may generate inspection results produced at least in part by the embodiments described herein, which may include information for the detected defects such as defect IDs, location, etc., of the bounding boxes of the detected defects, sizes, detection scores, information about defect classifications such as class labels or IDs, etc., or any such suitable information known in the art. The results for the defects may be generated by the computer subsystem in any suitable manner. The results for the defects may have any suitable form or format such as a standard file type. The computer subsystem may generate the results and store the results such that the results can be used by the computer subsystem and/or another system or method to perform one or more functions for the specimen or another specimen of the same type.

Results and information generated by performing the inspection on the specimen may be used in a variety of manners by the embodiments described herein and/or other systems and methods. Such functions include, but are not limited to, altering a process such as a fabrication process or step that was or will be performed on the inspected specimen or another specimen in a feedback or feedforward manner. For example, the computer subsystem may be configured to determine one or more changes to a process that was or will be performed on a specimen inspected as described herein based on the detected defect(s). The changes to the process may include any suitable changes to one or more parameters of the process. The computer subsystem preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem may determine such changes in any suitable manner known in the art.

Those changes can then be sent to a semiconductor fabrication system (not shown) or a storage medium (not shown) accessible to the computer subsystem and the semiconductor fabrication system. The semiconductor fabrication system may or may not be part of the system embodiments described herein. For example, the computer subsystem and/or imaging subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments of the system described above may be combined together into one single embodiment. In other words, unless otherwise noted herein, none of the system embodiments are mutually exclusive of any other system embodiments.

Another embodiment relates to a computer-implemented method for determining a signal-to-noise metric for locations of interest on a specimen. The method includes the finding a location of interest, acquiring a test and reference image, finding patch images in the reference image, identifying candidate patch images in the test image, eliminating any candidate patch images containing defect pixels, calculating one or more statistics, and calculating a signal-to-noise metric steps described herein. Each of the steps of the method may be performed as described further herein. The method may also include any other step(s) that can be performed by the imaging subsystem, computer subsystem, and DL model described herein. In addition, the method described above may be performed by any of the system embodiments described herein.

An additional embodiment relates to a non-transitory computer-readable medium storing program instructions executable on a computer system for performing a computer-implemented method for determining a signal-to-noise metric for locations of interest on a specimen. One such embodiment is shown in FIG. 11. In particular, as shown in FIG. 11, non-transitory computer-readable medium 1100 includes program instructions 1102 executable on computer system 1104. The computer-implemented method may include any step(s) of any method(s) described herein.

Program instructions 1102 implementing methods such as those described herein may be stored on computer-readable medium 1100. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 1104 may be configured according to any of the embodiments described herein.

Further modifications and alternative embodiments of various aspects of the invention will be apparent to those skilled in the art in view of this description. For example, methods and systems for determining a signal-to-noise metric for locations of interest on a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain attributes of the invention may be utilized independently, all as would be apparent to one skilled in the art after having the benefit of this description of the invention. Changes may be made in the elements described herein without departing from the spirit and scope of the invention as described in the following claims.

1. A system configured for determining a signal-to-noise metric for locations of interest on a specimen, comprising:
an imaging subsystem configured for generating images of the specimen; and
a computer subsystem configured for:
finding a location of interest in the images of the specimen and acquiring a test image and a reference image for the location of interest;
finding patch images in the reference image that are similar to a patch image in the test image at the location of interest;
identifying candidate patch images in the test image at locations of the found patch images;
eliminating any of the identified candidate patch images containing defect pixels thereby generating a population of background patch images in the test image;
calculating one or more statistics of non-defect signals from the population of background patch images; and
calculating a signal-to-noise metric for the location of interest from a signal for the location of interest in the test image and the one or more statistics.

2. The system of claim 1, wherein the one or more statistics comprise a center pixel mean and standard deviation along patch dimension.

3. The system of claim 1, wherein the one or more statistics comprise a per-pixel mean and standard deviation along patch dimension.

4. The system of claim 1, wherein the locations of interest comprise locations of defects detected in the images of the specimen, and wherein the computer subsystem is further configured for calculating the signal-to-noise metric for a population of the detected defects and generating input to a manual defect annotation method based on the calculated signal-to-noise metrics for the detected defects in the population.

5. The system of claim 4, wherein generating the input comprises guiding a user to the detected defects in the population having highest values of the calculated signal-to-noise metrics.

6. The system of claim 4, wherein the computer subsystem is further configured for generating a training set of defects based on results of the manual defect annotation method and training a deep learning model with the training set of defects.

7. The system of claim 6, wherein the deep learning model is configured for detecting defects on specimens.

8. The system of claim 6, wherein the deep learning model is configured for classifying defects detected on specimens.

9. The system of claim 1, wherein the locations of interest comprise locations of defects detected in the images of the specimen, and wherein the computer subsystem is further configured for calculating the signal-to-noise metric for a population of the detected defects, generating a training set of defects based on the calculated signal-to-noise metrics for the detected defects in the population, and training a deep learning model with the training set of defects.

10. The system of claim 1, wherein the imaging subsystem is further configured for generating additional images of an additional specimen, and wherein the computer subsystem is further configured for inputting the additional images into a deep learning model trained to detect defects on the additional specimen, calculating the signal-to-noise metric for locations of a population of the defects detected on the additional specimen by the deep learning model, and generating inspection results for the additional specimen by applying a threshold to the calculated signal-to-noise metrics for the locations of the defects in the population detected on the additional specimen.

11. The system of claim 10, wherein generating the inspection results comprises eliminating the defects in the population detected on the additional specimen having the signal-to-noise metric below the threshold from the inspection results.

12. The system of claim 1, wherein the computer subsystem is further configured for: determining one or more parameters of the imaging subsystem used for generating the images based on a relationship between the signal-to-noise metric and an inspection performance metric; and training a deep learning model with results generated for the specimen or an additional specimen with the images generated with the determined one or more parameters.

13. The system of claim 12, wherein the signal-to-noise metric in the relationship is the signal-to-noise metric for locations of defects of interest on the specimen or the additional specimen, and wherein the inspection performance metric is a repeatability for the deep learning model.

14. The system of claim 13, wherein determining the one or more parameters comprises modifying the one or more parameters until the signal-to-noise metric calculated for the locations of the defects of interest detected on the specimen or the additional specimen with the images generated with the modified one or more parameters is greater than or equal to a value of the signal-to-noise metric corresponding to a predetermined value of the repeatability.

15. The system of claim 1, wherein the locations of interest comprise locations of non-defects detected in the images of the specimen, wherein the computer subsystem is further configured for finding the locations of the non-defects by detecting events in the images generated of the specimen and separating the detected events into detected defects and the non-defects, and wherein the computer subsystem is further configured for calculating the signal-to-noise metric for the locations of a population of the non-defects and applying a threshold to the calculated signal-to-noise metrics for the locations of the non-defects in the population to thereby separate the non-defects that are true non-defects from the non-defects that are actual defects.

16. The system of claim 15, wherein the true non-defects comprise defects that are not visible to the imaging subsystem.

17. The system of claim 15, wherein the actual defects comprise novel defects or misclassified events.

18. The system of claim 15, wherein the computer subsystem is further configured for altering the threshold based on a predetermined capture rate for the actual defects.

19. A non-transitory computer-readable medium, storing program instructions executable on a computer system for performing a computer-implemented method for determining a signal-to-noise metric for locations of interest on a specimen, wherein the computer-implemented method comprises:
finding a location of interest in images of a specimen generated by an imaging subsystem and acquiring a test image and a reference image for the location of interest;
finding patch images in the reference image that are similar to a patch image in the test image at the location of interest;
identifying candidate patch images in the test image at locations of the found patch images;
eliminating any of the identified candidate patch images containing defect pixels thereby generating a population of background patch images in the test image;
calculating one or more statistics of non-defect signals from the population of background patch images; and
calculating a signal-to-noise metric for the location of interest from a signal for the location of interest in the test image and the one or more statistics.

20. A computer-implemented method for determining a signal-to-noise metric for locations of interest on a specimen, comprising:
finding a location of interest in images of a specimen generated by an imaging subsystem and acquiring a test image and a reference image for the location of interest;
finding patch images in the reference image that are similar to a patch image in the test image at a location of the location of interest;
identifying candidate patch images in the test image at locations of the found patch images;
eliminating any of the identified candidate patch images containing defect pixels thereby generating a population of background patch images in the test image;
calculating one or more statistics of non-defect signals from the population of background patch images; and
calculating a signal-to-noise metric for the location of interest from a signal for the location of interest in the test image and the one or more statistics, wherein the finding a location of interest, acquiring, finding patch images, identifying, eliminating, calculating one or more statistics, and calculating a signal-to-noise metric steps are performed by a computer subsystem.
